(19) United States
(12) Patent Application Publication
(10) Pub. No.: US 2011/0165292 A1
(43) Pub. Date: Jul. 7, 2011

(54) FOOD PRODUCT

(75) Inventors: Abdessamad Arrachid, Welwyn Garden City (GB); Carmen Tudorica, Clarens (CH)

(73) Assignee: NESTEC S.A., Vevey (CH)

(21) Appl. No.: 12/997,789

(22) PCT Filed: Jun. 12, 2009
(86) PCT No.: PCT/EP09/04244

§ 371 Date: Mar. 11, 2011

(30) Foreign Application Priority Data
Jun. 13, 2008 (GB) 0810856.5
Nov. 12, 2008 (GB) 0820696.3

(51) Int. Cl. A21D 10/00; A23L 1/00

(52) U.S. Cl. 426/103; 426/658; 426/549

(57) ABSTRACT

A no- or low-sugar wafer or an expanded extruded cereal product comprising monodisperse maltodextrins or fructooligosaccharides, methods of making these compositions and food products containing these compositions.

### FIELD OF THE INVENTION

The present invention relates to a moisture resistant or moisture tolerant product, such as a wafer or an expanded extruded cereal product, which contains maltodextrins or fructooligosaccharides with a monodisperse type molecular distribution.

### BACKGROUND OF THE INVENTION

Expanded extruded cereal products are made from starch-based extrudable dough which may be cooked in a single or a twin-screw extruder under high temperature, and which is then extruded through a die. Extrusion through a die may be accompanied by expansion, depending on the water content of the dough and depending on the pressure at the die. The product may then be cut and/or further processed and cooled. Such products are discussed in the text book “Extrusion Cooking, Technologies and Applications”, edited by Robin Guy, Woodhead Publishing, (2001) and an example of such a product is Nestlé Bocaditos as sold in Mexico.

Wafers are baked products which are made from wafer batter and have crisp, brittle and fragile consistency. They are thin, with an overall thickness usually from <1 to 4 mm and typical product densities range from 0.1 to 0.3 g/cm³.

Wafers are manufactured by preparing a batter containing mainly flour and water to which other minor ingredients may be added. A batter for use in the manufacture of commercial flat wafers typically contains 40 to 50% flour. Common formulations may also comprise at least one of the following ingredients: fat and/or oil, lecithin and/or emulsifiers, sugar, whole egg, salt, sodium bicarbonate, ammonium bicarbonate, skim milk powder, soy flour, yeast, and/or enzymes such as xylanases or proteases, for example.

Wafers may be distinguished from other biscuits/cookies in that wafers are the result of baking a batter whereas biscuits/cookies are usually baked out of dough. Batter is a liquid suspension that will flow through a pipe whereas biscuit dough is rather stiff to permit rolling and flattening and normally has a water content of less than 50 parts per 100 parts of flour.

Two basic types of wafer are described by K. F. Tiefenbacher in “Encyclopaedia of Food Science, Food Technology and Nutrition p 417-420—Academic Press Ltd London—1993”:

1) No- or low-sugar wafers. The finished biscuits contain from zero to a low percentage of sucrose or other sugars. Typical products are flat and hollow wafer sheets, moulded cones or fancy shapes.

2) High-sugar wafers. More than 10% of sucrose or other sugars are responsible for the plasticity of the freshly baked sheets. They can be formed into different shapes before sugar recrystallization occurs. Typical products are moulded and rolled sugar cones, rolled wafer sticks and deep-formed fancy shapes.

No- or low sugar wafers have a different texture and taste compared to high sugar wafers. When layered with a filling, they are used as the centre of well known chocolate confectionery products such as KIT KAT®.

In a common method of no- or low-sugar wafer manufacture, the batter is fed by pumping to a heated baking surface comprising a series of wafer baking moulds corresponding to the type of wafer desired, each wafer baking mould consisting of two heated engraved metal plates, also known as baking irons having upper and lower sections arranged to open and close, one of which may be moved relative to the other. The baking moulds are disposed one after the other, continuously circulating through a wafer oven by travelling from one end to the other and which are opened and closed in the front entrance of the wafer oven for the depositing of the batter and removal of the individual wafers. The wafer baking moulds pass through a baking oven for a determined time at a certain temperature, for instance 1-3 minutes at 140° C. to 180° C., to produce large flat wafer sheets with a low moisture content.

Wafers produced by extrusion are also known from WO 2008/031796 and WO 2008/031798.

The surfaces of wafers are precisely formed, following the surface shape of the plates between which they were baked. They often carry a pattern on one surface or on both. After cooling, the wafers are processed according to the requirements of the final product.

Enzymes may also be used in wafer manufacture. For example endo-proteinases (such as neutral bacterial proteinase from Bacillus subtilis or papain from Carica papaya) may be used to hydrolyse the peptide bonds in wheat gluten, which has the effect of preventing the formation of gluten lumps, and xylanase (pentosanase) may be used to hydrolyse the xylan backbone in arabinoxylan (pentosan), which has the effect of decreasing the water binding capacity of wheat pentosans, redistributing water among other flour components and reducing batter viscosity. Combinations of these enzymes may also be used, mainly to decrease batter viscosity, make batters more homogenous, increase machinability, allow standard flour grades to be employed and/or increase the flour level in batter. These preparations have become widely accepted (Food Marketing & Technology, April 1994, p. 14).

Light and crispy wafers or expanded extruded cereal products are highly appreciated by the consumer especially when combined with indulgent fillings. One of the main attributes of wafers and expanded extruded cereal products is their property of crispness when used in contact with components containing contrasting textures such as creams, jams or chocolate. However, a major disadvantage is that the level of crispness usually falls when wafers or expanded extruded cereal products absorb moisture from some of the components or the external environment. It is well known that, if the water content of a cereal wafer or extruded cereal increases beyond a certain level, the wafer or extruded cereal suffers a dramatic deterioration in quality, losing crispness and becoming cardboard-like and non-brittle. As a consequence, the wafer or expanded cereal is perceived as soggy and the final food products are undesirable to consumers.

WO 02/39820 seeks to provide baked food products with an increased crispiness at high moisture content by the use of sweeteners such as crystalline hydrate forming sugars (such as maltose, isomaltose, trehalose, lactose and raffinose) or high molecular weight starch hydrolysates. This approach is not suitable for no- or low sugar wafers which don't contain the required high levels of sweeteners. Further, batter containing sugars (e.g. glucose syrup or sucrose) or maltose (e.g. produced from the reaction of maltodextrins with the intrinsic alpha and beta amylase of the flour) has a tendency to stick to the plate during baking and so the wafer becomes difficult to release. In an industrial automatic plant, sticking wafers present a major problem as they are difficult to remove and end up being baked multiple times, thereby spoiling a percentage of the oven's output until the oven is stopped and the plates cleaned.

EP-A-1415539 discloses a flour based food product such as a wafer produced by using a thermostable alpha-amylase to manipulate textural properties of wafers. No mention is made of moisture tolerance. The use of α-amylase has been proposed to increase moisture tolerance in co-pending European patent application no. 07106604.7. The α-amylase is intended to catalyse the hydrolysis of the starch into smaller molecules. This in effect creates maltodextrin in situ. However, there are significant processing problems with the use of α-amylase. During baking on traditional wafer ovens, the action of the α-amylase produces a very low viscosity batter during the spreading of the batter when the plates close. As a result, a lot of batter is evacuated through the venting strips giving big moist doddings. Because of the increased spreadability, the resulting wafer is lighter (compared to a non α-amylase treated wafer for the same recipe), and hence more fragile at the release. Because of the big doddings sticking on the plate sides, the wafer release is not good and a high level of breakages is observed.

It is important that both expanded extruded cereal products and wafers are tolerant to moisture and in particular that they maintain their crisp brittle texture even if they are exposed to an environment having increased moisture content. Accordingly, it is an object of the present invention to provide wafers and expanded extruded cereal products which are moisture tolerant or moisture resistant. It is a further object of the invention to overcome the problems discussed above, in particular in relation to the processability of the wafer or expanded extruded cereal during production.

### SUMMARY OF THE INVENTION

The present invention seeks to overcome the above disadvantages by providing moisture resistance to the wafer or expanded extruded cereal product itself. We have surprisingly found that a moisture resistant expanded extruded cereal product or no- or low sugar wafer which maintains its crispness in high water activity environments may be prepared by using a monodisperse maltodextrins or fructooligosaccharides in the batter.

According to a first aspect the invention provides a no- or low-sugar wafer or an expanded extruded cereal product comprising monodisperse maltodextrins or fructooligosaccharides.

According to a second aspect the invention provides a wafer batter for a no- or low-sugar wafer or dough for an expanded extruded cereal product comprising monodisperse maltodextrins or fructooligosaccharides.

According to a further aspect the invention provides methods for making a wafer or an expanded extruded cereal product as described herein. Further the invention provides a food product comprising a wafer or an expanded extruded cereal product as described herein.

A further aspect of the invention provides the use of monodisperse maltodextrins or fructooligosaccharides in the production of a no- or low-sugar wafer or an expanded extruded cereal product to increase the moisture resistance of the wafer or product.

### BRIEF DESCRIPTION OF THE DRAWINGS

FIG. 1 shows the molecular distribution on a log scale for the maltodextrin 01910 C* Dry from Cargill. The black line shows the ideal target situation for a mono dispersion on a log scale. The dots correspond to the material we used that was the closest to the target.

FIG. 2 is a graph showing the moisture tolerance benefit of using monodisperse maltodextrins in wafer, as measured using the We methodology. A corresponds to a “classic” wafer and B corresponds to a wafer containing monodisperse maltodextrins in accordance with the invention.

### DETAILED DESCRIPTION OF THE INVENTION

The invention is based on the use of monodisperse maltodextrins or fructooligosaccharides in the production of no- or low sugar wafers and of expanded extruded cereal products that show high moisture resistance and good processability during manufacture.

In the present invention, no- or low sugar wafers are defined as wafers containing from 0 to 15% by weight sweetener, preferably from 0 to 10% by weight sweetener, more preferably from 0 to 8% by weight sweetener, and even more preferably from 0 to 5% sweetener based on the weight of the wafer. The sweetener may be sucrose or another sugar or a starch hydrolysate having a Dextrose Equivalents (DE) of greater than 20 or an inulin hydrolysate with a Fructose Equivalent of greater than 20 (where Fructose Equivalent is understood as an equivalent term to DE but applied to the hydrolysis products of inulin rather than starch, making an assumption that all the monomer units are fructose for this purpose), or mixtures of two or more of these sweeteners. Examples of sugars other than sucrose are, for example, glucose, lactose, maltose or fructose and crystalline hydrate formers such as isomaltose, trehalose, or raffinose. The wafer may also contain added enzymes such as proteinases and/or xylanases.

The wafer may be a flat wafer either having geometric shapes or cartoons character shapes, as well as alphabet letters or numbers, for example. It can also be a three dimensional shaped wafer such as, for example, a cone, a glass, a dish. Wafer texture results from the generation of gas cells in a gel structure mainly composed of gelatinised starch. The high temperature of the baking plates induces a rapid gelatinisation of starch granules present in the flour and production and expansion of the gas bubbles inside the gelatinous matrix. These gas cells are, in the common practice, mainly generated from gassing agents such as added bicarbonates or carbon dioxide produced by gas-generating microorganisms such as yeast during batter fermentation and from steam produced by heating. Therefore the wafer can be seen as a solid foam of gelatinised and dried starch/flour with dispersed gas cells (which can form an almost continuous phase in certain cases).

A wafer batter usually comprises around 40-50% flour, for example wheat flour, which itself contains approximately 70% of starch mainly occurring in the form of granules. In some batters, starch may be added in addition to the flour. The batter may also comprise at least one of the following ingredients: fat and/or oil, lecithin and/or emulsifiers, sugar, whole egg, salt, sodium bicarbonate, ammonium bicarbonate, skim milk powder, soy flour, yeast, and/or enzymes such as xylanases or proteases, for example. Any standard wafer batter may be used in accordance with the invention by adding monodisperse maltodextrins or fructooligosaccharides.

A wafer of the present invention may be prepared by any method known to the skilled person. For example, the moisture-resistant wafer may be prepared by a process comprising the steps of making a batter by mixing at least flour, water and monodisperse maltodextrins or fructooligosaccharides and baking it on at least one hot surface. The use of monodisperse maltodextrins or fructooligosaccharides does not bring any extra complexity to the wafer making process. Monodisperse maltodextrins or fructooligosaccharides are available as powders and may be added to the batter at the same time as the other ingredients. Alternatively the monodisperse maltodextrins or fructooligosaccharides may be added to the batter as a solution. In fact, the monodisperse maltodextrins or fructooligosaccharides may be added to the wafer batter at any time, but preferably at the same time as the other minor ingredients (e.g. sugar, fat, lecithin, sodium bicarbonate) or before the addition of flour.

Preferably, the wafer batter contains from 5 to 30%, preferably from 10 to 20%, most preferably from 13 to 15% by weight of monodisperse maltodextrins or fructooligosaccharides based on the weight of the wafer batter.

The invention also relates to expanded extruded cereal products. The composition of these products may comprise an expanded starch based material, for example potato starch or an expanded cereal material, such as corn, wheat, rice, barley or oat. The expanded extruded cereal product may have a high-, low- or no-sugar content. When making an expanded extruded cereal product a dough is formed by hydration of starch polymers. In addition to the starch based material (e.g. flour) and water, the dough may also comprise one or more of the following ingredients: sugar, soya isolate, milk powder, salt, calcium carbonate, oils and fats, such as hardened palm kernel oil, and flavourings. Any standard dough may be used in accordance with the invention by adding monodisperse maltodextrins or fructooligosaccharides. The density of expanded extruded cereal products according to the invention is preferably from 40 to 500 g/l.

An expanded extruded cereal product of the present invention may be prepared by any method known to the skilled person. For example, the moisture-resistant expanded extruded cereal product may be prepared by a process comprising the steps of making a dough by mixing at least flour, water and monodisperse maltodextrins or fructooligosaccharides. The dough may be fed into an extruder in which it may be further mixed and cooked. Cooking may be carried out at temperatures typically from 130 to 170° C., under 8 to 15 MPa. Under these conditions, the water in the dough is superheated whilst the dough is cooked. The cooked mixture is conveyed to the die where it is extruded through openings in the die. When the water-containing mixture, initially at high temperature and pressure, arrives at the die, water vaporises causing the extrudate to expand rapidly creating a foam structure. Traditionally, the extruded product directly expands by the instantaneous conversion of compressed liquid vapour into steam as the product flows through the die and into an ambient environment (moisture flash off process). The product is then dried to low moisture levels to stabilise it as a hard brittle structure.

The use of monodisperse maltodextrins or fructooligosaccharides does not bring any extra complexity to the production process. Monodisperse maltodextrins or fructooligosaccharides are available as powders and may be added to the dough at the same time as the other ingredients. Alternatively the monodisperse maltodextrins or fructooligosaccharides may be added to the dough as a solution. In fact, the monodisperse maltodextrins or fructooligosaccharides may be added to the dough at any time, but preferably at the same time as the other minor ingredients (e.g. sugar, fat, calcium carbonate) or before the addition of flour.

Preferably, the dough contains from 5 to 30%, preferably from 10 to 20%, most preferably from 13 to 15% by weight of monodisperse maltodextrins or fructooligosaccharides based on the weight of the dough.

A typical recipe for an expanded extruded cereal product according to the invention is shown below.

| | |
|---|---|
| Flour | 100 parts |
| Maltodextrins | 15 parts |
| Milk powder | 2 parts |
| Salt | 1.5 parts |
| Calcium carbonate | 1.5 parts |
| Oil and fat | 0.5 parts |
| Water | 3 parts |

Monodisperse maltodextrins or fructooligosaccharides are maltodextrins or fructooligosaccharides with a monodisperse type of molecular weight distribution. A monodisperse type of molecular weight distribution is understood herein to mean a monodistributed molecular weight distribution with a high polydispersity index. A high polydispersity index is understood to be preferably 18 or greater, preferably 21 or greater.

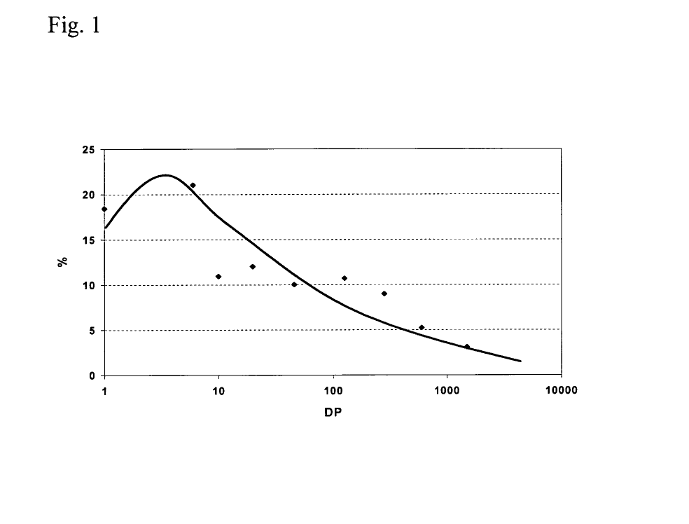

The term monodistributed molecular weight distribution may refer to a bell-shaped type of degree of polymerisation (DP) distribution, as shown in FIG. 1. In contrast, materials showing a polydistributed molecular weight distribution would show more than one bell-shaped distribution across the DP range. Typically a suitable monodisperse maltodextrin or fructooligosaccharide would comprise at least 50% of molecules (by weight) with a DP between 6 and 300. In accordance with the invention it is preferred that the monodisperse maltodextrins or fructooligosaccharides:

have molecules spread over a wide range of DP, in other words, the polydispersity index (PDI) should be 18 or above, preferably 21 or above;

with 0% to 30%, preferably greater than 0% to 20%, more preferably from 1 to 6%, most preferably about 5 to 6% by weight of molecules, having a low DP (<5);

with greater than 40%, preferably greater than 50%, by weight of molecules, having a medium DP (6 to 300);

the highest DP values should be greater than 1000, preferably greater than 1500. For example, 0% to 30%, preferably greater than 0% to 20%, more preferably from 1 to 6%, most preferably about 5 to 6% by weight of molecules, may have a high DP.

A monodisperse distribution has a progressive variation in high DP fraction characterised by a high polydispersity index (PDI). PDI is defined as the ratio between the weight average molecular weight and the number average molecular weight and refers to how broad is the DP range. The monodistribution according to the invention preferably presents a gentle slope towards higher DP so that the PDI is high (preferably 18 or above, more preferably 21 or above). The advantage of this distribution is that the different DP fractions do not behave independently and hence have individual impact on the processing.

It is advantageous to have molecules spread over a wide range of DP because it helps to dilute the effect of certain DP ranges and to preserve the texture of the wafer. In addition, it is advantageous to ensure a low proportion of molecules with a low DP because these molecules are responsible for the sticking of the wafer on the plates during baking, if used at too high a concentration. Further, when high concentrations of small sugars are used, the texture of the wafer is dramatically changed and it becomes very hard. This is generally not considered to be acceptable to the consumer who is seeking lightness in the wafer. It has been found that by using molecules with a wide range of DP overcomes these issues by delivering wafers that present satisfactory lightness and aeration.

The small number of molecules with low DP is advantageous because it is these low DP molecules that cause stickiness on the wafer baking plates.

The higher number of molecules with DP 6-300 is advantageous because the molecular weight of these molecules is high enough to avoid stickiness on the plate during baking, while providing the targeted Dextrose Equivalent.

Monodisperse maltodextrins according to the invention preferably have a Dextrose Equivalent (DE) of from 5 to 20, more preferably from 8 to 15 and most preferably about 10. Similarly monodisperse fructooligosaccharides according to the invention preferably have a Fructose Equivalent (FE) of from 5 to 20, more preferably from 8 to 15 and most preferably about 10. In this respect we understand FE to be an equivalent of DE in relation to the hydrolysis products of inulin (making an assumption that all the monomer units are fructose for this purpose).

To have good processability, a low or no-sugar wafer recipe should not cause the wafer to stick to the wafer baking plate after baking, the wafer should not be so friable as to make it difficult to transport and layer with filling creams without it breaking and the wafer batter should be stable for at least 30 minutes, preferably 1 hour after manufacture to allow storage of the batter before wafer baking.

Similarly, for expanded extruded cereal products the recipe should not lead to sticking and blocking within the extruder or at the die.

By using a monodisperse distribution of maltodextrins or fructooligosaccharides, the right combination of long and short chain length allows a reduction in the overall susceptibility of the maltodextrins or fructooligosaccharides to Maillard reactions that are at the origin of the stickiness on the wafer plates, in the extruder or at the die. This combination of long and short chain length provides enough molecular entanglement and reduces significantly the free volume for molecular motions. As a result, a higher moisture tolerance is provided and maintained without the negative effect on processing which the smaller chain lengths would have caused.

Preferred embodiments of the invention use monodisperse maltodextrins that may be derived from corn, wheat, rice, cassaya or potatoes, most preferably corn. Examples of monodisperse maltodextrins which work in accordance with the invention are C*Dry 01910 Corn Maltodextrin and Dry MD 01913, both from Cargill®. Other preferred embodiments of the invention use monodisperse fructooligosaccharides that may be derived from bananas, onions, chicory root, garlic, asparagus, barley, wheat, jícama, tomatoes, leeks, Jerusalem artichokes or yacón. Commercially available monodisperse fructooligosaccharides may be used.

FIG. 1 shows the molecular distribution on a log scale for the maltodextrin 01910 C* Dry from Cargill®. The black line shows the ideal target situation for a mono dispersion on a log scale. The dots correspond to the material used in the example that was the closest to the target. This material demonstrates the important factors of a spread over a wide range of DP, with the proportion of low DP (<5) less than 20% and the proportion of medium DP (6 to 300) more than 50%.

In accordance with the invention, preferably neither the wafer batter nor the wafer contain extrinsic α-amylase. Similarly, preferably neither the dough nor the expanded extruded cereal products contain extrinsic α-amylase.

Crispness is an attribute that relates to the number of mechanical fractures that occur upon application of a certain force and to the magnitude of the force needed to cause a fracture. Ways to quantify crispness are known in the art, notably from Mitchell, J. R. et al. in Journal of the Science of Food and Agriculture, 80, 1679-1685, 2000. Thus, crispness can be quantified by a number of parameters.

The crispness of wafers or expanded extruded cereal products may be evaluated by a penetration test (also known as a puncture test or crush test) which is performed by using a texture analyser able to record force/distance parameters during penetration of a probe into the wafer or product. The instrument forces a cylindrical probe into a stack of five wafers and the structural ruptures (force drops) are recorded over a certain distance. The frequency of force drops allows discrimination between wafer textures whereby the higher the number of force drops, the higher the crispness. The conditions used for this test were:

### Texture Analyser TA.HD, Stable Micro Systems, England;

Load cell 50 kg;
4 mm diameter cylinder stainless probe;
Penetration rate 1 mm/s;

### Distance 8 mm;

Record of force drops greater than 0.2N;
Trigger force greater than 0.5N;
Acquisition rate 500 points per second.

Van Hecke E. (1991), (“Contribution a l'étude des propriétés texturals des produits alimentaires alvéolés. Mise au point de nouveaux capteurs. Ph.D. Thesis, Université de Technologie de Compiègne”) proposed a method based on 4 parameters to characterise force-deformation curve. Changes in moisture tolerance may be associated to one of these parameters—crispiness work, Wc—which is defined as Crispness Work, Wc (N·mm). N·mm (Newton millimetre) is the non-SI work unit used.

$$Wc ( N . mm ) = \frac{( A / d )}{( No / d )}$$

Where No; total number of peaks

d=distance of penetration (mm)

A=Area under the force-deformation curve (N·mm)

The above equation could be simplified to Wc=A/No. The slope and the value of We will vary depending on the density of the wafer. In other words the value of We will depend on the water:flour ratio in the batter recipe. At similar weight, wafers tends to have similar hardness, which corresponds to the A value (area under the force-deformation curve (N·mm)) for the calculation of Wc.

A standard wafer tends to lose its perceived crispness progressively as the water activity is raised above 0.3. This loss of crispness is a continuum (continuous changes upon hydration) with many factors having an influence such as the recipe, density, geometry, etc. Using the above penetration test, we have shown that the We of standard wafers starts to increase as the water activity is raised from 0.1 to 0.25. Once the water activity of a standard wafer is increased above about 0.3, an increase in water activity of 0.1 results in an increase in the We of the said standard wafer greater than 2.

As used herein the terms “moisture resistant” and “moisture tolerant” mean the same thing and will be used interchangeably. Accordingly, a moisture resistant wafer is defined herein as a wafer that maintains crispness in high water activity environments, i.e. it maintains its mechanical resistance and its initial sensory attributes when equilibrated at elevated water activity levels such that at water activities from 0.3 to 0.4, surprisingly from 0.4 to 0.5, and more surprisingly from 0.5 to 0.6, an increase of 0.1 in water activity results in a Wc increase less than 2 N·mm. Preferably at water activities from 0.3 to 0.6, an increase of 0.1 in water activity results in a Wc increase less than 1.5, more preferably less than 1.25, and more preferably less than 1.0 N·mm. At higher water activities a greater moisture tolerance may be observed in comparison with the standard wafer. Accordingly, preferably at water activities from 0.3 to 0.7, an increase of 0.1 in water activity results in a Wc increase less than 2-fold, preferably less than 1.5-fold and more preferably less than 1.25-fold.

The wafer or the expanded extruded cereal product of the invention can be presented to the consumer as a wafer or an expanded extruded cereal product by itself, but it can also be further processed to form a confectionery or savoury food product or a pet food. Therefore, the present invention also comprises a food product comprising a moisture-resistant wafer or an expanded extruded cereal product as described above in contact with another food material. The other food material may be a confectionery or savoury food product or a pet food. Preferably the wafer or expanded extruded cereal product is in direct contact with the food material.

Conventional food materials may be used and examples of suitable food materials are chocolate, jelly, compound chocolate, ice-cream, sorbet, nut paste, cream-based products, cake, mousse, nougat, caramel, praline, jam, wafer rework or a combination of these ingredients with or without inclusions of the same ingredient in a different state or of a different ingredient. For savoury products suitable food materials would include fish or meat paste, cheese-based materials or vegetable puree. Such a food product may include one or more of these other materials as fillings for the wafer or expanded extruded cereal product. The food material may contain a high water activity. In the present invention, for a food material with a filling, after equilibration between the filling and the wafer/expanded extruded cereal product, an acceptable sensory perception may be achieved for a water activity of up to 0.65, preferably up to 0.55. However, the filling may have previously had a higher water activity value since it will lose moisture during the equilibration phase. For example, it is possible to make a sandwich bar composed of external layers of wafers framing the same or different fillings. The sandwich can also be a succession of a wafer and filling pair, the first and last layers being wafer, comprising from 2 to 15 wafer layers. Although the use of a moisture barrier is generally unnecessary, a moisture barrier may optionally be used if desired.

It is also possible to use the wafer or expanded extruded cereal product as the centre or part of the centre of a confectionery or savoury product or a pet food. The wafer or expanded extruded cereal product may be enrobed or moulded in the coating material which can be any of the usual coatings, for example a chocolate, compound, icing, caramel or combinations of these. Preferably the food product is a confectionery product.

Since the wafers and expanded extruded cereal products of the present invention maintain desired textural qualities such as crispness or brittleness at high water activities, the invention allows the production of novel confectionery products with healthier fillings such as low-fat or low-calorie fillings, or new fillings such as caramel, fruit jam or a real fruit filling, where the wafer or expanded extruded cereal product is in direct contact with the filling without the need of a moisture barrier.

### EXAMPLES

The following examples are illustrative of the products and methods of making the same falling within the scope of the present invention. They are not to be considered in any way limitative of the invention. Changes and modifications can be made with respect to the invention. That is, the skilled person will recognise many possible variations in these examples covering a wide range of compositions, ingredients, processing methods, and mixtures, and can adjust the naturally occurring levels of the compounds of the invention for a variety of applications.

Wafers were baked according to the following formulations:

For a “classic” wafer, the following recipe was used:

### Recipe A

| | |
|---|---|
| Flour | 100.0 parts |
| Water | 110.0 parts |
| Sucrose | 2.0 parts |
| Fat | 1.0 parts |
| Lecithin | 0.2 parts |
| Sodium bicarbonate | 0.2 parts |

For a wafer containing monodisperse maltodextrins in accordance with the invention, the following recipe was used:

### Recipe B

| | |
|---|---|
| Flour | 100.0 parts |
| Water | 120.0 parts |
| Maltodextrins | 15.0 parts |
| Fat | 1.0 parts |
| Lecithin | 0.2 parts |
| Sodium bicarbonate | 0.2 parts |

In Recipe B, the water amount has been increased to produce wafers with similar weight to those produced by following Recipe A. This is to ensure that the We values measured for each type of wafer are comparable.

The wafers were prepared by baking the batters for 2 minutes in an oven (25-plate wafer oven, Hebenstreit Moerfelded, West Germany) between two metal plates heated to 130° C. After short cooling, samples were hydrated in climatic chambers at the desired water activity (Aw) for 15 days before mechanical testing. The Aw was measured in each sample after hydration to verify the correct hydration of the sample.

In order to assess the moisture tolerance of the wafers, a texture analyser able to record force/distance parameters during penetration of a probe into the wafer was used as described above. The instrument forces a cylindrical probe into a stack of five wafers and the structural ruptures (force drops) are recorded. The frequency of force drops allows discrimination between wafer textures whereby the higher the number of force drops, the higher the crispiness. The conditions used for this test were: Texture Analyser TA.HD, Stable Micro Systems, England; load cell 50 kg; 4 mm diameter cylinder stainless probe; penetration rate 1 mm/s; distance 8 mm; record of force drops greater than 0.2N; trigger force greater than 0.5N; acquisition rate 500 points per second.

The mechanical properties of the different wafers were analysed using a method based on the following 4 parameters which were used to characterise force-deformation curve.

### Wc=Crispness Work (N·mm)

No=total number of peaks
d=distance of penetration (mm)
A=Area under the force-deformation curve (N·mm)

Changes in moisture tolerance may be associated to crispiness work, Wc which is defined as:

$$Wc ( N . mm ) = \frac{( A / d )}{( No / d )} = \frac{A}{No}$$

The lower the value of Wc, the crisper the wafer. The lower the increase in Wc for a given increase in water activity, the greater the moisture tolerance.

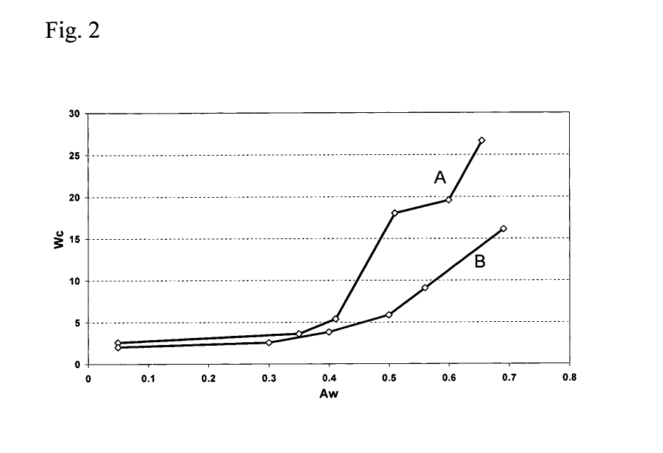

The graph shown in FIG. 2 shows the moisture tolerance benefit of using the maltodextrins as measured using the Wc methodology. In the graphs, A and B correspond to the recipes above. A lower Wc means a crisper wafer. Above 0.4 Aw, a clear benefit is observed with the Wc in using the maltodextrins. For example, the wafer with maltodextrins at Aw 0.6 has a value for Wc of half that of the wafer without maltodextrins. Further the steeper gradient of the graph for the standard wafer clearly shows that this wafer is less moisture tolerant than the wafer containing maltodextrins. In particular, for the standard wafer, at water activities from 0.4 to 0.7, an increase of 0.1 in water activity results in large increases in Wc, some of them greater than 2-fold. In contrast, for the wafer containing maltodextrins, at water activities from 0.4 to 0.7, an increase of 0.1 in water activity results in much smaller increases in Wc, for example, less than 2-fold.

1. A no- or low-sugar wafer or an expanded extruded cereal product comprising monodisperse maltodextrins and fructooligosaccharides.

2. A wafer or an expanded extruded cereal product according to claim 1 wherein the monodisperse maltodextrins are derived from a source selected from the group consisting of corn, wheat, rice, potatoes and cassaya.

3. A wafer or an expanded extruded cereal product according to claim 1 wherein the monodisperse maltodextrins are derived from corn.

4. A wafer or an expanded extruded cereal product according to claim 1 wherein the monodisperse maltodextrins comprise an ingredient selected from the group consisting of C*Dry 01910 Corn Maltodextrin and Dry MD 01913, from Cargill®.

5. A wafer or an expanded extruded cereal product according to claim 1 wherein the distribution of maltodextrin or fructooligosaccharide molecules is such that:
the polydispersity index (PDI) is at least 18;
0% to 30%, by weight of molecules, have a degree of polymerisation of not greater than 5;
greater than 40%, by weight of molecules have a degree of polymerisation from 6 to 300; and
the highest DP values are greater than 1000.

6. A wafer or an expanded extruded cereal product according to claim 1 wherein the wafer or expanded extruded cereal product does not contain extrinsic α-amylase.

7. A wafer or an expanded extruded cereal product according to claim 1 wherein the wafer or product contains from 5 to 30%, by weight of monodisperse maltodextrins or fructooligosaccharides based on the weight of the wafer or product.

8. A wafer or an expanded extruded cereal product according to claim 1 wherein at water activities from 0.3 to 0.6, an increase of 0.1 in water activity results in a We increase less than 2.0 N·mm.

9. A wafer or an expanded extruded cereal product according to claim 1 wherein the monodisperse maltodextrins have a Dextrose Equivalent (DE) of from 5 to 20, or the fructooligosaccharides have a Fructose Equivalent of from 5 to 20.

10. A wafer batter for a no- or low-sugar wafer or a dough for an expanded extruded cereal product comprising an ingredient selected from the group consisting of monodisperse maltodextrins and fructooligosaccharides.

11. A batter or dough according to claim 10 wherein the monodisperse maltodextrins are derived from a source selected from the group consisting of corn, wheat, rice, potatoes and cassaya.

12. A batter or dough according to claim 10 wherein the monodisperse maltodextrins are derived from corn.

13. A batter or dough according to claim 10 wherein the monodisperse maltodextrins comprise an ingredient selected from the group consisting of C*Dry 01910 Corn Maltodextrin and Dry MD 01913, from Cargill®.

14. A batter or dough according to claim 10 wherein the distribution of maltodextrin or fructooligosaccharide molecules is such that:
the polydispersity index (PDI) is at least 18 or above;
0% to 30%, by weight of molecules, have a degree of polymerisation of not greater than 5;
greater than 40%, by weight of molecules have a degree of polymerisation from 6 to 300; and
the highest DP values are greater than 1000.

15. A batter or dough according to claim 10 wherein the batter or dough does not contain extrinsic α-amylase.

16. A batter or dough according to claim 10 wherein the batter or dough contains from 5 to 30%, by weight of monodisperse maltodextrins or fructooligosaccharides based on the weight of the batter or dough.

17. A batter or dough according to claim 10 wherein the monodisperse maltodextrins have a Dextrose Equivalent (DE) of from 5 to 20, or the fructooligosaccharides have a Fructose Equivalent of from 5 to 20.

18. A food product comprising a wafer or an expanded extruded cereal product comprising monodisperse maltodextrins and fructooligosaccharides and another edible material.

19. A food product according to claim 18 wherein the other edible material is selected from the group consisting of a confectionery, savoury and pet food material.

20. A food product according to claim 18 wherein one or more of the other edible materials are included as a filling for the wafer or expanded extruded cereal product.

21. A food product according to claim 19 wherein the wafer or expanded extruded cereal product is at least a part of the center of the food.

22. A food product according to claim 18 wherein the wafer or expanded extruded cereal product is in direct contact with the food material with no moisture barrier.

23. A method of producing a no- or low-sugar wafer or an expanded extruded cereal product to increase the moisture resistance of the wafer or product comprising the step of using an ingredient selected from the group consisting of monodisperse maltodextrins or fructooligosaccharides.

24. Method for making a no- or low-sugar wafer comprising the steps of making a batter comprising an expanded extruded cereal product comprising the steps of mixing at least flour, water and monodisperse maltodextrins or fructooligosaccharides and baking it on at least one hot surface.

25. Method for making an expanded extruded cereal product comprising the steps of making a dough for an expanded extruded cereal product by mixing at least flour, water and monodisperse maltodextrins or fructooligosaccharides and extruding the dough through a cooker extruder.
